(19) United States
(12) Patent Application Publication
(10) Pub. No.: US 2020/0390102 A1
(43) Pub. Date: Dec. 17, 2020

(54) SYNERGISTIC ANTIMICROBIAL COMPOSITION

(71) Applicant: DDP SPECIALTY ELECTRONIC MATERIALS US, INC., Wilmington, DE (US)

(72) Inventors: Geert Van Der Kraan, Horgen (CH); Nora Eibergen, Wilmington, DE (US); Nigel Watson, Wlmington, DE (US); Imke Widera, Horgen (CH); Kenneth Wunch, Houston, TX (US); James Donovan, Houston, TX (US)

(21) Appl. No.: 16/767,192

(22) PCT Filed: Dec. 17, 2018
(86) PCT No.: PCT/US18/65914

§ 371 Date: May 27, 2020

Related U.S. Application Data
(60) Provisional application No. 62/607,434, filed on Dec. 19, 2017.

(51) Int. Cl. A01N 57/20; A01N 35/02

(52) U.S. Cl. CPC A01N 57/20; A01N 35/02

(57) ABSTRACT

A synergistic antimicrobial composition having two components. The first component is tetrakis(hydroxymethyl)phosphonium sulfate. The second component is glyoxal.

This invention relates to combinations of functional chemicals, the combinations having greater antimicrobial activity than would be observed for the individual compounds.

Use of combinations of at least two compounds can broaden potential markets, reduce use concentrations and costs, and reduce waste. In some cases, commercial antimicrobial compounds cannot provide effective control of microorganisms, even at high use concentrations, due to weak activity against certain types of microorganisms, or relatively slow antimicrobial action, or instability under certain conditions such as high temperature and high pH. Combinations of different active agents are sometimes used to provide overall control of microorganisms or to provide the same level of microbial control at lower use rates in a particular end use environment. For example, U.S. Pat. No. 8,952,199 discloses a combination of tetrakis(hydroxymethyl)phosphonium sulfate and glutaraldehyde, but this reference does not suggest the combination claimed herein. Moreover, there is a need for additional combinations of functional chemicals having enhanced activity to provide effective control of the microorganisms. The problem addressed by this invention is to provide such additional combinations of functional chemicals.

### STATEMENT OF THE INVENTION

The present invention is directed to a synergistic antimicrobial composition comprising: (a) tetrakis(hydroxymethyl)phosphonium sulfate; and (b) glyoxal; wherein a weight ratio of tetrakis(hydroxymethyl)phosphonium sulfate to glyoxal is from 1:0.34 to 1:20.8.

### DETAILED DESCRIPTION OF THE INVENTION

As used herein, the following terms have the designated definitions, unless the context clearly indicates otherwise. The term “antimicrobial compound” refers to a compound capable of inhibiting the growth or propagation of microorganisms, and/or killing microorganisms; antimicrobial compounds include bactericides, bacteristats, fungicides, fungistats, algaecides and algistats, depending on the dose level applied, system conditions and the level of microbial control desired. The term “microorganism” includes, for example, fungi (such as yeast and mold), bacteria and algae. The term “H₂S scavenger” refers to a compound capable of reacting irreversibly with H₂S/HS⁻/S²⁻ species dissolved in the multiphase fluids and water-phases and thereby rendering the adverse effects of these components harmless as they are now bound. The following abbreviations are used throughout the specification: ppm=parts per million by weight (weight/weight), mL=milliliter, Unless otherwise specified, temperatures are in degrees centigrade (° C.), and references to percentages are by weight (wt %). Percentages of antimicrobial compounds in the composition of this invention are based on the total weight of active ingredients in the composition, i.e., the antimicrobial compounds themselves, exclusive of any amounts of solvents, carriers, dispersants, stabilizers or other materials which may be present. The term “THPS” refers to tetrakis(hydroxymethyl)phosphonium sulfate.

Preferably, a weight ratio of THPS to glyoxal is from 1:0.34 to 1:7.5, respectively, preferably from 1:0.34 to 1:1 or 1:1.4 to 1:20.8, preferably from 1:0.34 to 1:1 or 1:1.4 to 1:7.5.

In some embodiments of the invention, the antimicrobial composition is substantially free of other antimicrobial compounds, i.e, it has less than 5% of other antimicrobial compounds relative to total biocide active ingredient content, alternatively less than 2%, alternatively less than 1%, alternatively less than 0.5%, alternatively less than 0.1%.

The compositions of this invention may contain other ingredients, e.g., defoamers and emulsifiers. The microbicidal compositions of the present invention can be used to inhibit the growth of microorganisms or higher forms of aquatic life (such as protozoans, invertebrates, bryozoans, dinoflagellates, crustaceans, mollusks, etc) by introducing a microbicidally effective amount of the compositions into an aqueous medium subject to microbial attack. Suitable aqueous media are found in, for example: petroleum processing fluids; fuel; oil and gas field functional fluids, such as injection fluids, hydraulic fracturing fluids, produced fluids, drilling mud, completion and workover fluids; oil and gas pipelines, separation, refining, transportation, and storage system; industrial process water; electrocoat deposition systems; cooling towers; air washers; gas scrubbers; mineral slurries; wastewater treatment; ornamental fountains; reverse osmosis filtration; ultrafiltration; ballast water; evaporative condensers; heat exchangers; pulp and paper processing fluids and additives; starch; plastics; emulsions; dispersions; paints; latices; coatings, such as varnishes; construction products, such as mastics, caulks, and sealants; construction adhesives, such as ceramic adhesives, carpet backing adhesives, and laminating adhesives; industrial or consumer adhesives; photographic chemicals; printing fluids; household products, such as bathroom and kitchen cleaners; cosmetics; toiletries; shampoos; soaps; personal care products such as wipes, lotions, sunscreen, conditioners, creams, and other leave-on applications; detergents; industrial cleaners; floor polishes; laundry rinse water; metalworking fluids; conveyor lubricants; hydraulic fluids; leather and leather products; textiles; textile products; wood and wood products, such as plywood, chipboard, flakeboard, laminated beams, oriented strandboard, hardboard, and particleboard; agriculture adjuvant preservation; nitrate preservation; medical devices; diagnostic reagent preservation; food preservation, such as plastic or paper food wrap; food, beverage, and industrial process pasteurizers; toilet bowls; recreational water; pools; and spas.

The specific amount of the microbicidal compositions of this invention necessary to inhibit or control the growth or metabolic activity of microorganisms in an application will vary. Typically, the amount of the composition of the present invention is sufficient to control the growth or metabolic activity of microorganisms if it provides from 1 to 5000 ppm (parts per million) active ingredients of the composition. It is preferred that the combination of active ingredients (i.e., THPS and Glyoxal) of the composition be present in the medium to be treated in an amount of at least 10 ppm, preferably at least 300 ppm, preferably at least 500 ppm, and preferably at least 1000 ppm. It is preferred that the active ingredients of the composition be present in the locus in an amount of no more than 5000 ppm, preferably no more than 2000 ppm, preferably no more than 1000 ppm, preferably no more than 500 ppm, preferably no more than 300 ppm. In a method of this invention, a composition is treated to control microbial growth or metabolic activity by adding, together THPS and glyoxal in amounts that would produce the concentrations indicated above.

The present invention also encompasses a method for preventing microbial growth in the use areas described above, especially in oil or natural gas production operations, by incorporating the claimed biocide combination into the materials. Preferably, a method for controlling growth of Ps. aeruginosa comprises treatment of a medium which may contain Ps. aeruginosa with a combination of THPS and glyoxal in a range from 1:1.4 to 1: 20.8, respectively, preferably from 1:1.4 to 1:7.5. Preferably, a method for controlling growth of T. thermophilus comprises treatment with a combination of THPS and glyoxal in a range from 1:0.34 to 1:1. Preferably, the medium is an aqueous medium.

### EXAMPLES

### Example 1

### Synergy in the Planktonic Phase

Pseudomonas aeruginosa (ATCC 8739) and Escherichia coli (ATCC 10145) cultures were separately prepared from glycerol stocks. First they were streak plated and validated with a microscope. Single colonies were picked and used to inoculate 200 mL shake flasks that were grown statically overnight at 30° C. (30 grams/L Tryptic Soy Broth) to produce the initial inoculum. A deep-well 96 well challenge plate (2 mL maximum well volume) was prepared using 900 μL/well phosphate buffer at pH 7.3, (0.0027M potassium chloride, 0.137 M sodium chloride). Inoculation took place at the start of the experiments (with a 100 μL combined inoculum, adding to the 900 μL buffer to total 1 mL/well). The inoculum added between 1*10⁸ and 1*10⁹ total cells/mL based on OD₆₀₀ measurement. The concentrations (in ppm) used for the synergy experiments are as follows: THPS—0, 30, 50, 70, 90, 110, 130, 150; glyoxal—0, 125, 250, 375, 500, 625, 750, 875. Each experiment was done in triplicate.

The inoculated assay block was challenged at 30° C. for 48 hours. After the 48 hour challenge with biocide under static conditions, 20 μL aliquots of each treatment (well) were transferred to corresponding wells of a 96 well plate filled with 180 μL per well of ‘recovery’ media (30 grams/L Tryptic Soy Broth). This was done in triplicate for each point (the triplicate is already present in the biocide block viz. each point is truly determined in triplicate). After pipetting the plates, they were sealed with a titer top and incubated at 30° C. in a non-shaking incubator.

The recovery plates were subsequently read (checked for microbial growth) at 72 hours after addition of the culture, to recovery media. Ranking of biocidal efficacy was done by recording the development of turbidity within each well (determined by visual inspection). A development of turbidity indicated the growth of cells and the failure of the biocidal formulation in question. Ranking was done per average value of three data points determined per experiment. (Recorded in log regrowth).

Experiments using Thermus thermophdus (DSM: 579) as a test organism were also performed. In these experiments, the total concentration of biocides was 300 ppm for the combined total actives, the temperature at which the experiments were performed was 60° C., the media to grow Thermus thermophdus was DSMZ DSM 74-Media at pH 8.0. (Yeast extract (BD Difco) 4.0 g, Proteose peptone Nr. 3 (BD Difco) 8.0 g, NaCl 2.0 g, distilled water added to 1 L). The challenging with biocides against Thermus thermophilus was done in a standard ocean matrix with a similar salinity of 2% (similar to the media where they are cultured in). The concentration ranges are listed in Table 1. Once again, each experiment was done in triplicate.

TABLE 1*
Concentrations of THPS and Glyoxal in the
synergy experiments. (Thermus thermophilus)
In experiment combinations (listed in ppm)
Stand alone (ppm)

| THPS (1:1) | Glyoxal | THPS (1:3**) | Glyoxal | THPS | Glyoxal |
|---|---|---|---|---|---|
| 150 | 150 | 75 | 225 | 300 | 300 |
| 100 | 100 | 50 | 150 | 200 | 200 |
| 67 | 67 | 33 | 100 | 133 | 133 |
| 44 | 44 | 22 | 67 | 89 | 89 |
| 30 | 30 | 15 | 44 | 59 | 59 |
| 20 | 20 | 10 | 30 | 40 | 40 |
| 13 | 13 | 7 | 20 | 26 | 26 |
| 0 | 0 | 0 | 0 | 0 | 0 |

*Thermus thermophilus is more sensitive to Glyoxal vs. Pseudomonas aeruginosa and E. coli.
**The inverted 3:1 for THPS/Glyoxal was also tested (not shown, no synergy was detected at this ratio).

The inoculated assay block was challenged at 60° C. for 48 hours. The inoculum prepared added between to 1*10⁸ to 1*10⁹ total cells/mL (determined by MPN analysis). After 48 hours of challenge with biocide, 20 μL aliquots of each treatment (well) were added to one of several 96 well plates with DSM 74-media. These 96 well plates were filled with ‘recovery’ media (DSM 74-Media). One of these plates was prepared for each column of the assay block. 180 μL recovery media was added to each well of a 96 well plate, except for column 1 of the recovery plate. This column was filled with 180 μL of one column of the assay block. The last three columns on the recovery plate were not pipetted. These columns represented the no template control for verifying proper plate set up and data reliability. The assay block sample was then diluted in steps of 10 fold by transferring 20 μL from e.g. columns 1 to column 2 and from column 2 to column 3 (until column 9) by applying a multichannel pipet in each recovery plate. After pipetting the plates, they were sealed with a B-seal and incubated at 60° C. in a non-shaking incubator.

The recovery plates were allowed to regrow for 4-6 days and subsequently read (checked for microbial growth). This was done in duplicate for each point (the duplicate is already present in the biocide block viz. each point is truly determined in duplicate). Ranking of biocidal efficacy was done by recording turbidity, each recovery plate was placed on a plate shaker (MixMate, Eppendorf), holding the 10 log dilution series. The plates were shaken for a short time (10-20 seconds), at 1600 rpm to homogenize the samples. The turbidity was checked via a white sheet background with a black line, turbidity was observed via a positive and negative control comparison. Turbidity was checked in log scale reading the recovery plates. Turbidity was recorded via presence/absence and gave the log kill range (from the made dilution series).

Synergy Ratio Determined Using the Following Formulae.

Table 2 summarizes the efficacy of THPS and glyoxal and their combinations, as well as the Synergy Index of each combination. one measure of synergism is the industrially accepted method described by Kull, F. C.; Eisman, P. C.; Sylwestrowicz, H. D. and Mayer, R. L., in Applied Microbiology 9:538-541 (1961),

using the ratio determined by the formula:

Qa/QA+Qb/QB=Synergy Index (“SI”)

Wherein:

Qa=Concentration of biocide A required to achieve a certain level of kill when used in combination with B

QA=Concentration of biocide A required to achieve a certain level of kill when used alone

Qb=Concentration of biocide B required to achieve a certain level of kill when used in combination with A

QB=Concentration of biocide B required to achieve a certain level of kill when used alone

When the sum of Qa/QA and Qb/QB is greater than 1.0, antagonism is indicated. When the sum is 1.0, additivity is indicated, and when less than 1.0, synergism is demonstrated.

TABLE 2
Summarized synergy values, determined after 48 hours

| | Ratio THPS/ | THPS stand alone | Glyoxal stand alone | THPS in formulation | Glyoxal in formulation | |
|---|---|---|---|---|---|---|
| Bacterial system | Glyoxal | 48 h pass (ppm) | 48 h pass (ppm) | 48 h pass (ppm) | 48 h pass (ppm) | Synergy index |
| P. aeruginosa/ | 1:25 | 130 | 875 | 30 | 750 | 1.09 |
| E. coli | | | | | | |
| P. aeruginosa/ | 1:20.8 | 130 | 875 | 30 | 625 | 0.95 |
| E. coli | | | | | | |
| P. aeruginosa/ | 1:7.5 | 130 | 875 | 50 | 375 | 0.81 |
| E. coli | | | | | | |
| P. aeruginosa/ | 1:5 | 130 | 875 | 50 | 250 | 0.67 |
| E. coli | | | | | | |
| P. aeruginosa/ | 1:3.6 | 130 | 875 | 70 | 250 | 0.82 |
| E. coli | | | | | | |
| P. aeruginosa/ | 1:1.4 | 130 | 875 | 90 | 125 | 0.84 |
| E. coli | | | | | | |
| T. thermophilus | 1:1 | 300 | 59 | 20 | 20 | 0.41 |
| T. thermophilus | 1:0.34 | 300 | 59 | 44 | 15 | 0.8 |

### Example 2

### Chemical Compatibility Study.

Formulations of biocide with sulfide scavenger are known to have compatibility issues. For example, mixing triazine chemistries with CMIT/MIT leads to heavy coloring and precipitation formation. Formulation of glyoxal with BIT at a low pH is difficult to achieve due to poor dissolution of BIT.

Chemical compatibility of THPS and glyoxal was tested by mixing together glyoxal, 12.5% A.I. and THPS, 33% A.I. (final pH=1.25) and observing any changes in color, temperature, and precipitation.

TABLE 3
Chemical Compatibility Study

| Time Point | Precipitation | Color | Temperature |
|---|---|---|---|
| Start of | no precipitation | clear | no temperature change |
| experiment | observed | colorless | during the first 2.5 |
| | | liquid | minutes after mixing |
| After 1 day | no precipitation | clear | n/a |
| | observed | colorless | |
| | | liquid | |
| After 4 days | no precipitation | clear | n/a |
| | observed | colorless | |
| | | liquid | |
| After 7 days | no precipitation | clear | n/a |
| | observed | colorless | |
| | | liquid | |

1. A synergistic antimicrobial composition comprising: (a) tetrakis(hydroxymethyl)phosphonium sulfate; and (b) glyoxal; wherein a weight ratio of tetrakis(hydroxymethyl)phosphonium sulfate to glyoxal is from 1:0.34 to 1:20.8.

2. The synergistic antimicrobial composition of claim 1 in which the weight ratio of THPS to glyoxal is from 1:0.34 to 1:7.5.

3. A method for inhibiting growth of Pseudomonas aeruginosa or Escherichia coli comprising adding to a medium which may contain at least one of Pseudomonas aeruginosa and Escherichia coli a combination of THPS and glyoxal in a range from 1:1.4 to 1: 20.8.

4. A method for inhibiting growth of Thermus thermophilus comprising adding to a medium which may contain Thermus thermophilus a combination of THPS and glyoxal in a range from 1:0.34 to 1:1.
